(19) United States
(12) Patent Application Publication
(10) Pub. No.: US 2017/0000027 A1
(43) Pub. Date: Jan. 5, 2017

(54) Robotic harvester

(71) Applicant: Terence D. Hunt, Dayton, OH (US)

(72) Inventor: Terence D. Hunt, Dayton, OH (US)

(21) Appl. No.: 14/545,890

(22) Filed: Jul. 2, 2015

(51) Int. Cl. A01D 46/30

(52) U.S. Cl. CPC A01D 46/30

(57) ABSTRACT

An improvement in robotic harvesting machines. A robotic harvester that consists of robotic arm(s) mounted on vehicles that can pick low-lying fruits and vegetables in all weather, 24 hours per day, 7 days per week, without damaging delicate crops. This robotic harvester is unique because it can find ripe crops such as strawberries, pick them, pack them and in some cases transport them to a storage area with no damage. This robotic harvester 1) Uses an advanced system to find ripe fruit, utilizing an innovative arrangement of state-of-the-art sensors; 2) Uses an innovative approach to picking delicate fruit, including a custom cutter/grasping design that does not touch the fruit or crops, only the stem; and 3) Uses proprietary control software.

This application claims benefit of U.S. Provisional Patent application No. 61/998,730 was filed Jul. 7, 2014 which is herein incorporated by reference in its entirety.

### TECHNICAL FIELD AND INDUSTRIAL APPLICABILITY OF THE INVENTION

An improvement in robotic harvesting machines. A robotic harvester that consists of robotic arm(s) mounted on vehicles that can pick low-lying fruits and vegetables in all weather, 24 hours per day, 7 days per week, without damaging delicate crops. This invention is unique in the type and arrangement of sensors, the cutter/gripper design, how it picks from the stem and thus doesn't damage delicate crops, and in other aspects.

### BACKGROUND OF THE INVENTION

While machines have long been used in agriculture, humans are still used to harvest many types of low-lying crops, such as strawberries, because until now viable technology has not existed. Harvesting crops such as strawberries is technologically complicated because the harvester needs to locate and pick only ripe berries, to handle them gently, and to harvest them during a short ripeness window. This is a complicated task because crops such as strawberries grow close to the ground, can be obscured by leaves, are of varying sizes, and must be picked at a specific ripeness, as they will not ripen after being picked. Further, crops such as strawberries must be handled gently because they bruise easily and consumers will not purchase bruised fruit.

This invention overcomes the technology obstacles posed by these challenges and utilizes state of the art technology and innovative engineering to effectively and properly harvest crops such as strawberries.

### BRIEF SUMMARY OF THE INVENTION

An improvement in robotic harvesting machines. A robotic harvester that consists of robotic arm(s) mounted on vehicles that can pick low-lying fruits and vegetables in all weather, 24 hours per day, 7 days per week, without damaging delicate crops. This robotic harvester is unique because it can find ripe crops such as strawberries, pick them, pack them and in some cases transport them to a storage area with no damage. This robotic harvester 1) Uses an advanced system to find ripe fruit, utilizing an innovative arrangement of state-of-the-art sensors; 2) Uses an innovative approach to picking delicate fruit, including a custom cutter/grasping design that does not touch the fruit or crops, only the stem; and 3) Uses proprietary control software.

### BRIEF DESCRIPTION OF THE FIGURES

FIG. 1 depicts an overview of the robotic harvester. The robotic harvester depicts a vehicle (1), a robotic arm section (2), individually controlled servo units (3) a light (4), a proprietary gripper/cutter mechanism (5), vehicle guidance sensors and lighting (6), and a drive system (7). The vehicle in (1) is all-weather, includes turntable for robotic arm, navigation system (inertial and/or GPS), wi-fi enabled main processor, microcontrollers, power source, motor, and collision avoidance system. The robotic arm section in (2) is all-weather. (3) consists of individually controlled servo motor joint units: light, medium or heavy-duty servo units, depending on which type of crops the robot is harvesting. The light in (4) is LED type, all-weather. The gripper/cutter in (5) is designed to cut the stem and grip the stem, and will not grab the crop/fruit itself. Sensors in (6) consist of one or more stereo cameras, 3D, short-wave infrared, long-wave infrared, mounted near the end of the arm, and there is space for additional robotic arms. Item (7) describes that the drive system can be wheels, treads, or other appropriate system.

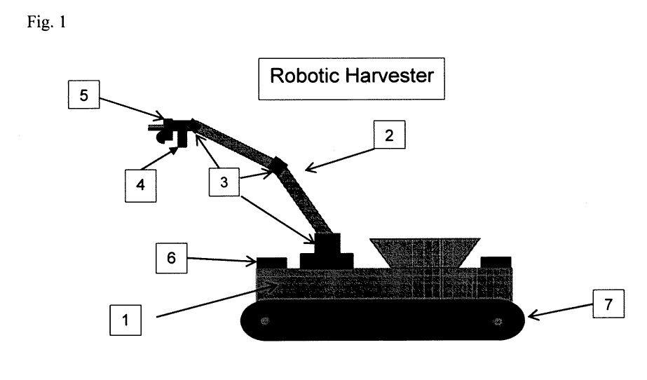

FIG. 2 depicts a front view of one example of the gripper/cutter mechanism, showing the gripper/cutter (8).

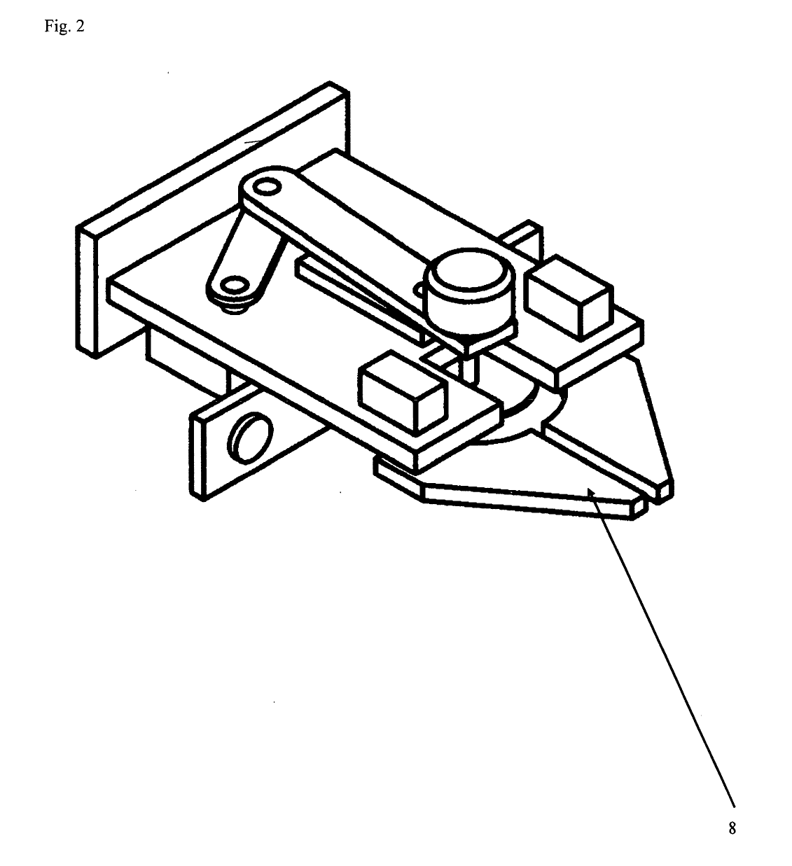

1. A method for the robotic picking of stemmed crops by the stem, comprising the use of a robotic mechanism comprising an arm or arms mounted on a moveable base, having a gripper/cutter mechanism that contains an attached or embedded blade, wherein the mechanism is configured in a way that it grabs and cuts the stem without grabbing the crop itself, whereby the crop is picked without being damaged.

2. The method of claim 1, wherein the arm comprises crop locator and crop identification sensors proximate to the gripper/cutter that search for and identify the crop to be picked, and wherein the arm places the picked crop in a predesignated location, and the robotic harvester includes sensors that are capable of providing data on crop yield, soil moisture, weeds and pesticides.

3. A method of robotic harvesting, comprising multiple robotic mechanisms, each robotic mechanism comprising an arm having a gripper/cutter mechanism that contains an attached or embedded blade, wherein the mechanism is configured in a way that grabs and cuts the stem without grabbing the crop itself, whereby the crop is picked without being damaged, wherein the robotic mechanisms work with a networked group of robotic mechanisms and/or crop transports, and communicate with each other regarding crop volume and capacity, moisture levels, weeds and pesticide needs, and/or other data.
